(19) United States
(12) Patent Application Publication
(10) Pub. No.: US 2002/0161629 A1
(43) Pub. Date: Oct. 31, 2002

(54) METHOD FOR PROVIDING FINANCIAL INCENTIVE FOR INTERACTING WITH AN INTERNET WEBSITE

(76) Inventor: KEITH JENTOFT, CIRCLE PINES, MN (US)

Correspondence Address: MARK LEVY, SALZMAN & LEVY, 19 CHENANGO ST, STE 606, BINGHAMTON, NY, 13901

(21) Appl. No.: 09/347,701

(22) Filed: Jul. 3, 1999

(51) Int. Cl. G06F 17/60

(52) U.S. Cl. 705/14

(57) ABSTRACT

The present invention provides a unique way to attract prospective buyers, customers, bidders, and survey participants to an internet website. A predetermined, target population of people having interest in the information, merchandise, or service is selected and provided with a machine-readable debit card. The selected population is informed of the location of the website, the nature of the website content and/or of the terms of the incentive. Each member may visit the website and register. Upon completion of a predetermined task to ensure the effectiveness of the presentation, the registered visitor is provided a personalized identification number (PIN). The machine-readable access (debit) card may them be taken to an ATM machine where, by use of the PIN, the prospect receives a cash incentive payment.

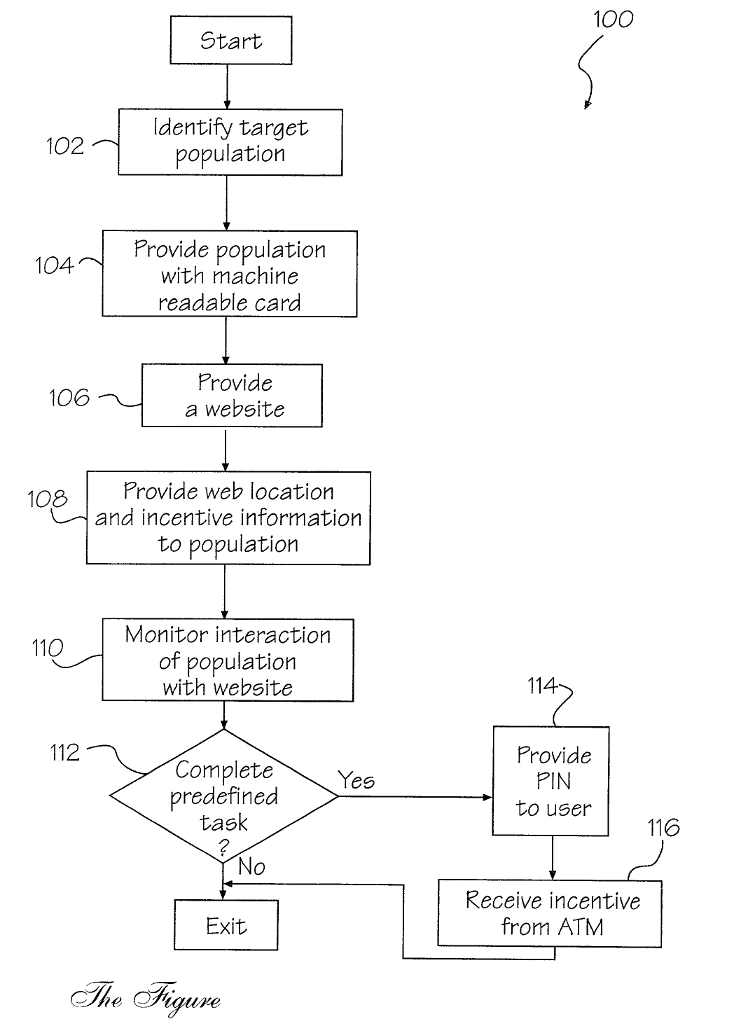

### FIELD OF THE INVENTION

The invention pertains to rewarding a perspective buyer, target audience, or participant for viewing a sales presentation, participating in a survey, and receiving training etc., and, more particularly, to providing a financial incentive to a perspective buyer or participant for viewing a particular internet website and/or participating in an activity provided thereat.

### BACKGROUND OF THE INVENTION

The field of marketing is concerned with trying to find cost-effective ways to inform or influence prospective buyers of goods and services. Marketing presentations are often accompanied by some form of financial incentive. This may be a simple incentive, for instance, enclosing a dollar bill inside a survey. The nature of the financial incentive is often a check or credit document mailed by a fulfillment company under contract to the marketing company. This strategy usually results in the familiar “allow 6 to 8 weeks for delivery” message. Unfortunately, the time delay in delivering the incentive may dull the effect on potential customers, shoppers, bidders and clients. In other strategies, discount coupons or the like may be awarded. Again, significant time may be required between the viewing of the marketing presentation and the receipt of the coupon. In addition, redemption of the coupons may require purchasing a marginally-needed product or service. This too tends to minimize the effectiveness of the incentive plan.

Similar problems arise is attempting to obtain subjects to complete surveys or polls, participate in training, view promotional materials and other such activities.

The rapid growth of the internet and worldwide websites have provided a totally new suite of tools for accomplishing marketing, polling, surveying, or similar tasks. As a greater and greater segment of the world's consuming population acquires internet access, more and more commerce will be conducted over the internet. The medium provides an advertiser's dream in being able to provide sophisticated presentations of advertising and/or educational materials, including multi-page, full color, animated visual presentations. In addition, sound may be included. The web may be used for delivering targeted “infomercials” designed to influence viewers. Such infomercials may utilize quantitative feedback. Viewers may be guided along individualized paths, examining only areas of specific interest to them. While the cost of designing, mounting and maintaining a sophisticated website may be considerable, that cost is insignificant compared to the cost of designing, printing and mailing four-color advertising/informational packages or the like, or using other conventional print, radio, or television marketing approaches. The cost of broadcast and print media is often wasted by targeting too broad an audience. There has heretofore been no way to easily provide a rapid incentive to a potential viewer of such a website. Other promotional vehicles have difficulty providing real-time feed back and responses.

It is, therefore, an object of the invention to provide a method for attracting a target audience to a particular internet website by offering an essentially immediate financial incentive directly to participants.

It is also an object of the invention to provide a novel online mechanism to qualify customers, shoppers, bidders, or clients.

It is a further object of the invention to provide a predetermined target population with an individualized, machine readable access card.

It is an additional object of the invention to provide a mechanism for ensuring that visitors to the website complete a predetermined sequence of steps or a “quiz” to provide that a minimum level of contact with the website.

It is a still further object of the invention to provide to target population members, upon successful completion of a task at the website, a PIN or other similar verification of their successful completion.

It is another object of the invention to provide a cash incentive payout to participants from an ATM in cooperation with the machine-readable card and the PIN.

It is another object of the invention to provide a payout which may be varied in real-time based on responses to a quiz or another measurement of perceived value of the participant to the sponsor.

### SUMMARY OF THE INVENTION

The present invention provides a unique way to attract prospective buyers to an internet website. A predetermined, target population of people having potential interest in the information, merchandise, or service is selected and provided with machine-readable cards. The selected population is informed of the location of the website, the specific information content of the website and of the terms or the incentive. Each member may visit the website and register. Upon completion of a predetermined task to ensure the effectiveness of the presentation, the registered visitor is provided a unique personal identification number “PIN”. The machine-readable access card may them be taken to an ATM machine or other designated delivery center where, by use of the PIN, the prospect receives a cash incentive payment or other incentive such as sporting event tickets, coupons for services, free parking vouchers, etc.

### BRIEF DESCRIPTION OF THE DRAWING

A complete understanding of the present invention may be obtained by reference to the accompanying drawing, when considered in conjunction with the subsequent detailed description, in which THE FIGURE is a flowchart of the steps of the inventive method.

### DESCRIPTION OF THE PREFERRED EMBODIMENT

Generally speaking, the present invention relates to providing a financial or other incentive to an individual for viewing and/or participating in a sales presentation, survey, etc., and, more specifically, to a method for providing such presentations on an internet website and making the financial incentive available quickly after the completion of the presentation.

The term “internet” is used generically herein to refer to an interactive, computer-based platform generally accessible to a large number of people, worldwide. The worldwide web or internet is dynamic. The internet of last month is different than the internet this month. Changes are occurring at a breathtaking pace. It is therefore anticipated that the inventive method may be applied to future environments other than the internet as it is known at the time of application; the invention is not considered limited to the present internet application and configuration.

Referring to THE FIGURE, there is shown a flow chart 100 illustrating the steps of the inventive method. First, a target population is identified, step 102. Many conventional techniques for selecting a target population are well known to advertising executives, pollsters, and others interested in selling goods or services, educating, or surveying individuals or organizations. Any technique, including the internet itself, may be used to select a population from individuals or organizations with a high probability of interest in the subject matter being presented or sold.

Each member of the target population is provided with a unique machine-readable card such as a debit card, step 104. Magnetically encoded cards, programmed smart cards, bar coded documents, any other machine-readable document may be used. The cards may be mailed to individuals, handed or delivered to individuals at a meeting, or distributed in any other manner required by the specific circumstance or marketing program. In alternate embodiments and existing credit/debit card or the like could be used in lieu for providing a new card. At the conclusion of the program, this existing credit card could be utilized to receive the incentive as described in more detail hereinbelow.

Alternately, a participant could utilize one or more biometric input devices (e.g., fingerprint reader, retinal scanner, etc.) to register a unique biological characteristic upon entry to the internet website. This unique, registered biological characteristic could later be used to identify a participant instead of a PIN or the like.

An internet website having the necessary information, survey, sales presentation or the like is provided, step 106. The construction, mounting and maintenance of internet websites is well known to those skilled in the art and does not form a part of the instant invention. Specifically, the website contains a provision for registering a visitor and determining if the visitor is one of a predetermined list of visitors (i.e., members of the target population). Access information may be included on the card previously provided to potential participants. Access may be denied to an unknown visitor or the unknown visitor may be allowed full or partial access to the site.

The target population is provided with information regarding the location (address) of the website, the nature of the material on the website and the financial incentive, step 108. Multiple websites may be created and the members of the target population informed of multiple websites at the same time. Notification of the population may be done in a variety of ways such as e-mail, other cross-linked websites, newspapers, broadcast or cable TV, radio, surface mail, courier service such as FedEx® or the like, telephone, etc. Any other method may be used to convey the information to the members of the target population.

Known visitors are given specific instructions for completing a predetermined task. The task may simply be to review a number of screens and/or, at the end of the review, to take a quiz to ensure that the visitor has completed the assigned task. The website may include text, pictures, sound, and/or video provided in manners well known to those skilled in the art.

The website is monitored for access by the members of the target population, step 110. When a population member visits the site, he or she is provided with instructions and options for completing the presentation or survey, step 110. There is a predetermined, minimum amount of contact required to ensure that enough information has been imparted to the visitor to qualify him or her for the financial incentive. The visitor's trail through the website may be captured and analyzed to determine compliance. Alternatively, at the end of the session, the visitor may be quizzed to quantify how much information has been imparted to the participant. Other techniques, including simple or sophisticated response analysis may be employed to determine a visitor's qualification for receipt of the financial incentive. The incentive may vary with different levels of participation chosen by the participant, for instance $10 to view the website or $20 if the quiz is taken.

If the visitor is deemed to have successfully completed the task, step 112, he or she are provided with a unique personal identification number (PIN), step 114, corresponding to the machine-readable card previously provided, step 104. Many techniques may be employed to ensure the authenticity of the PIN. Some obvious methods included the use of check sums or treating the PIN as an encryption key. The PIN may be unique, individualized to each participant, or, in alternate embodiments, a common PIN number may be employed. The PIN may also be varied to conform to the level of participation and/or the amount of the incentive to be paid to the participant.

With the machine-readable card previously provided (step 104) and the PIN number acquired at the completion of the internet session, step 114, the population member may immediately proceed to an Automated Teller Machine (ATM) and use the card, in cooperation with the PIN, to obtain a predetermined amount of cash from the ATM, step 116.

There may be many variations of the inventive method disclosed hereinabove. For example, the machine-readable cards may be single use or multiple use, depending upon the nature of the incentive program, new PINs allowing additional disbursement of cash upon completion of additional tasks at either the original or a different internet website.

The amount of the financial incentive may be vary from participant to participant and/or session to session, based on quiz results, or by using a strategy such as rewarding the first n participants with a higher amount, etc.

The incentives, whether cash or non-cash, may be delivered to the participants in a wide variety of ways. Cash incentives are readily delivered by ATM or similar machines. Cash incentives may also be delivered by agencies such as banks, or express services, or agencies such as Western Union, etc. Tickets to sporting, theatrical, or similar events may easily be delivered by automated ticket dispensing machines such as those operated by Ticket Masters® or the like. Discount coupons, passes, or other similar incentives may be dispensed by agencies retained to perform these delivery services.

The inventive method provides a highly cost-effective way to reach a target population. Money typically wasted in inefficient media delivery may be spent directly to influence specific target audiences. The effectiveness of an incentive program is enhanced by the ability to deliver a cash incentive immediately upon completion of the program.

It is anticipated that the inventive method or minor variations thereof may be useful in marketing situations such as new product announcements.

Programs may also be designed for use by a manufacturer to maintain positive influence over a third-party sales force (i.e., manufacturer's representatives, distributors, resellers, etc.) regarding products, promotions and training.

Similarly, the inventive system can be used advantageously in conjunction with online auctions, on-line advertising, subscribing to magazines and video clubs, registering for educational seminars, etc.

Another benefit of the inventive method is that the sponsor may obtain immediate feedback regarding the effectiveness of the programs. The program itself may be quickly and inexpensively alterer to maximize its effectiveness.

There is essentially no limit to the range of incentives and/or delivery systems which may be used with the inventive method. For example, while financial incentives in the form of cash may readily be delivered at ATM, tickets could, for example, be made available through Ticketmaster®, Ticketron®, etc. Specified payout agents could also be utilized.

The card provided potential participants could also be a multi-purpose card. Some examples are a buyers club card, a frequent traveler card, etc.

Another way in which financial incentives could be delivered to participants is through the addition of value to a debit-card as used in an “electronic purse” application. An electronic purse is a re-writable smart card which may be used like a credit or debit card. Like the well known prepaid phone cards, the electronic purse has a predetermined spending value. Also like some prepaid phone cards, the electronic purse may have additional value added, generally at a terminal or the like whereupon communicating with a bank, credit union, or other financial institution, value is transferred from an account to the smart card. In some implementations, small terminals attached to a telephone may be used to perform the replenishment of the electronic purse.

In alternate embodiments, multiple sponsors may organize to host an internet event in which a target audience is incented to visit a “virtual trade show” and receive an incentive after viewing a collection of websites. This could provided a larger incentive than might be provided by an individual sponsor.

Since other combinations, modifications and changes varied to fit particular operating requirements and environments will be apparent to those skilled in the art, the invention is not considered limited to the chosen preferred embodiments for purposes of this disclosure, but covers all changes and modifications which do not constitute departures from the true spirit and scope of this invention.

Having thus described the invention, what is desired to be protected by Letters Patent is presented in the subsequently appended claims.

What is claimed is:

1. A method for providing incentive for interacting with a particular internet website, the steps comprising:
a) providing a website having information about at least one predetermined subject area, said website comprising means for monitoring completion of a predetermined task;
b) providing each member of a target population with a unique, machine-readable access card;
c) monitoring completion of said predetermined task by members of said target population; and
d) providing an incentive to said members of said target population upon successful completion of said predetermined task.

2. The method for providing incentive for interacting with a particular internet website as recited in claim 1, the steps further comprising:
e) selecting a target population from people having potential interest in said at least one predetermined subject areas.

3. The method for providing incentive for interacting with a particular internet website as recited in claim 2, the steps further comprising:
f) providing each member of said target population individualized information upon successful completion of said task.

4. The method for providing incentive for interacting with a particular internet website as recited in claim 3, the steps further comprising:
g) providing information to said target population about at least one from the group of: website address and nature of the incentive.

5. The method for providing incentive for interacting with a particular internet website as recited in claim 1, wherein said personalized, machine-readable card comprises at least one from the group of: uniquely encoded magnetic stripe card, uniquely programmed smart card and bar coded document.

6. The method for providing incentive for interacting with a particular internet website as recited in claim 1, wherein said step (b) of providing each member of said target population with a personalized, machine-readable access card comprises delivering a card to each member.

7. The method for providing incentive for interacting with a particular internet website as recited in claim 1, wherein said step (b) of providing each member of said target population with a personalized, machine-readable access card comprises distributing said cards to a group of internet users.

8. The method for providing incentive for interacting with a particular internet website as recited in claim 3, wherein said step (f) of providing each member of said target population individualized information upon successful completion of said task comprises providing a PIN.

9. The method for providing incentive for interacting with a particular internet website as recited in claim 1, wherein said providing a website step (a) comprises providing a group of related websites.

10. The method for providing incentive for interacting with a particular internet website as recited in claim 9, wherein said providing a financial incentive step (d) comprises providing a varying financial incentive dependent upon what combination of websites from said group of related websites have had interaction.

11. The method for providing incentive for interacting with a particular internet website as recited in claim 1, wherein said providing an incentive step (d) comprises providing a cash incentive at an ATM.

12. The method for providing incentive for interacting with a particular internet website as recited in claim 1, wherein said providing an incentive step (d) comprises providing a cash incentive via one from the group of: bank and agent.

13. The method for providing incentive for interacting with a particular internet website as recited in claim 1, wherein said providing an incentive step (d) comprises providing a increase of value to an electronic purse smart card.

14. The method for providing incentive for interacting with a particular internet website as recited in claim 1, wherein said providing an incentive step (d) comprises providing a non-cash incentive.

15. The method for providing incentive for interacting with a particular internet website as recited in claim 14, wherein said non-cash incentive is a admission ticket provided by an automated ticket vending service.

16. The method for providing incentive for interacting with a particular internet website as recited in claim 14, wherein said non-cash incentive is at least one from the group of: admission ticket, discount coupon and golf greens fee.

17. The method for providing incentive for interacting with a particular internet website as recited in claim 1, the steps further comprising:
registering each member of said target population at said internet website.

18. The method for providing incentive for interacting with a particular internet website as recited in claim 17, wherein said registering step (h) comprises receiving a debit/credit card number from at least one of said members of said target population.

19. The method for providing incentive for interacting with a particular internet website as recited in claim 17, wherein said registering step (h) comprises receiving a unique biological characteristic from at least one of said members of said target population.
